(19) United States
(12) Patent Application Publication
(10) Pub. No.: US 2022/0172271 A1
(43) Pub. Date: Jun. 2, 2022

(54) METHOD, DEVICE AND SYSTEM FOR RECOMMENDING INFORMATION, AND STORAGE MEDIUM

(71) Applicant: BOE Technology Group Co., Ltd., Beijing (CN)

(72) Inventor: Xibo ZHOU, Beijing (CN)

(21) Appl. No.: 17/535,961

(22) Filed: Nov. 26, 2021

(30) Foreign Application Priority Data
Nov. 30, 2020 (CN) 202011379303.0

(51) Int. Cl. G06Q 30/06; G06K 9/62; H04N 5/232; G06V 40/16; G06F 16/73

(52) U.S. Cl. CPC G06Q 30/0631; G06K 9/6267; G06K 9/6201; G06F 16/73; H04N 5/23293; G06V 40/172; G06V 40/171; H04N 5/23219

(57) ABSTRACT

A method for recommending information includes: acquiring video information of a presentation area where a display terminal is located; performing face image recognition on the video information; acquiring, in response to determining that a user to which a face image acquired by the recognition belongs is paying attention to the display terminal, preference degrees of the user for a plurality of pieces of to-be-presented information; and sending target to-be-presented information with a target preference degree to the display terminal.

### CROSS-REFERENCE TO RELATED APPLICATION

This application is based on and claims priority to the Chinese Patent Application No. 202011379303.0, filed on Nov. 30, 2020 and entitled “METHOD, APPARATUS, DEVICE, AND SYSTEM FOR RECOMMENDING INFORMATION, AND STORAGE MEDIUM,” the disclosure of which is incorporated herein by reference in its entirety.

### TECHNICAL FIELD

The present disclosure relates to the fields of information processing and transmission technologies, and in particular to a method, a device and a system for recommending information, and a storage medium.

### BACKGROUND

With the advent of the Internet of Things era, many industries change their business models from traditional outlet-based business models to Internet business models, and then, back to offline outlet-based models while introducing some automated sale schemes, thereby implementing automated sale services.

### SUMMARY

The present disclosure provides a method, a device and a system for recommending information, and a storage medium.

According to one aspect, a method for recommending information is provided. The method includes:

acquiring video information of a presentation area where a display terminal is located;

performing face image recognition on the video information;

acquiring, in response to determining that a user to which a face image acquired by the recognition belongs is paying attention to the display terminal, preference degrees of the user for a plurality of pieces of to-be-presented information; and

sending target to-be-presented information with a target preference degree to the display terminal.

In some embodiments, before acquiring the preference degrees of the user for the plurality of pieces of to-be-presented information, the method further includes:

determining, by tracing the face image of the user in the video information, whether a duration for which the user has been facing the display terminal is longer than an attention duration threshold; and

determining, in response to the duration for which the user has been facing the display terminal being longer than the attention duration threshold, that the user is paying attention to the display terminal.

In some embodiments, acquiring the preference degrees of the user for the plurality of pieces of to-be-presented information includes:

acquiring the plurality of pieces of to-be-presented information;

acquiring user information of the user, wherein the user information includes at least one of: a user portrait of the user or search action feedback information of the user for to-be-presented information, wherein the user portrait is built from the face image, and the search action feedback information is feedback information on a presence of the user's search action and is acquired based on the video information; and

determining a respective preference degree of the user for each piece of to-be-presented information based on the plurality of pieces of to-be-presented information and the user information.

In some embodiments, acquiring the user portrait includes:

determining whether the user is a registered user by comparing the face image with registered face images in a face database;

building, in response to the user being determined as a registered user, the user portrait of the user based on registration information of the user; and

acquiring, in response to the user being determined as an unregistered user, face attribute information of the user by performing face attribute recognition on the face image of the user; and

building the user portrait of the user based on the face attribute information.

In some embodiments, acquiring the face attribute information of the user by performing the face attribute recognition on the face image of the user includes:

recognizing the face image of the user via a face attribute recognition model; and

acquiring the face attribute information output by the face attribute recognition model;

wherein the face attribute recognition model includes at least one of: a classification model or a regression model.

In some embodiments, acquiring the search action feedback information of the user for the to-be-presented information includes:

determining searched to-be-presented information from the to-be-presented information;

acquiring positional information of an image corresponding to the search action in the video information by performing search action recognition on the video information; and

acquiring the search action feedback information by matching the search action with a nearest face image and the searched to-be-presented information based on the positional information.

In some embodiments, determining the searched to-be-presented information from the to-be-presented information includes:

acquiring search information provided by the display terminal; and

determining, based on the search information, the searched to-be-presented information from the to-be-presented information.

In some embodiments, the search action includes any one of: a code scanning action or a touch operation on the display terminal.

In some embodiments, determining the respective preference degree of the user for each piece of to-be-presented information includes:

acquiring the respective preference degrees of the user for the plurality of pieces of to-be-presented information by inputting the plurality of pieces of to-be-presented information and the user information into a preference degree computation model, wherein the preference degree computation model is pre-built according to a Factorization Machine.

In some embodiments, sending the target to-be-presented information with the target preference degree to the display terminal includes:

ranking the plurality of pieces of to-be-presented information based on the preference degrees of the user for the plurality of pieces of to-be-presented information; and

sending at least one piece of top-ranked to-be-presented information as the target to-be-presented information to the display terminal.

In some embodiments, there are a plurality of users, and determining the respective preference degree of the user for each piece of to-be-presented information based on the plurality of pieces of to-be-presented information and the user information includes:

acquiring the respective preference degree of each of the users for each piece of to-be-presented information by inputting the plurality of pieces of to-be-presented information and the user information of the plurality of users into a preference degree computation model, wherein the preference degree computation model is built according to a Factorization Machine; and

determining a respective average preference degree for each piece of to-be-presented information based on the respective preference degree of each of the users for each piece of to-be-presented information, wherein the average preference degree for any piece of to-be-presented information indicates an average of the preference degrees of the plurality of users for the piece of to-be-presented information.

In some embodiments, sending the target to-be-presented information with the target preference degree to the display terminal includes:

ranking the plurality of pieces of to-be-presented information based on the average preference degrees for the plurality of pieces of to-be-presented information; and

sending at least one piece of top-ranked to-be-presented information as the target to-be-presented information to the display terminal.

In some embodiments, determining the respective average preference degree for each piece of to-be-presented information based on the respective preference degree of each of the users for each piece of to-be-presented information includes:

determining whether the plurality of users are registered users by comparing face images of the plurality of users with registered face images in a face database;

determining weights of the plurality of users, wherein among the plurality of users, registered users have a first weight, and unregistered users have a second weight; and

determining a respective average preference degree for each piece of to-be-presented information based on the respective weight of each of the users and the respective preference degree of each of the users for each piece of to-be-presented information, wherein the average preference degree for any piece of to-be-presented information indicates a weighted average of the preference degrees of the plurality of users for the piece of to-be-presented information.

In some embodiments, determining whether the plurality of users are registered users by comparing face images of the plurality of users with the registered face images in the face database includes:

acquiring a to-be-compared feature vector of the face image of any one of the users;

determining that the user is a registered user in response to a cosine similarity between the to-be-compared feature vector and a feature vector of a registered face image in the face database being greater than a similarity threshold; and

determining that the user is an unregistered user in response to cosine similarities between the to-be-compared feature vector and a respective feature vector of each registered face image in the face database being less than or equal to the similarity threshold.

In some embodiments, after performing the face image recognition on the video information, the method further includes:

sending preset to-be-presented information to the display terminal in response to no face image being recognized, wherein the preset to-be-presented information is at least one of: hot to-be-presented information, latest to-be-presented information, or random to-be-presented information in the plurality of pieces of to-be-presented information.

According to another aspect, a device for recommending information is provided. The device includes a memory and a processor, wherein

the memory stores one or more computer programs, and the processor executes the one or more computer programs to perform:

acquiring video information of a presentation area where a display terminal is located;

performing face image recognition on the video information;

acquiring, in response to determining that a user to which a face image acquired by the recognition belongs is paying attention to the display terminal, preference degrees of the user for a plurality of pieces of to-be-presented information; and

sending target to-be-presented information with a target preference degree to the display terminal.

According to still another aspect, a system for recommending information is provided. The system includes an image acquisition device, a display terminal, and the device for recommending information as defined above, wherein

both the image acquisition device and the display terminal are in communicative connection with the device for recommending information;

the image acquisition device is configured to collect an image of the presentation area where the display terminal is located so as to provide the video information of the presentation area; and

the display terminal is configured to present the target to-be-presented information sent by the device for recommending information.

In some embodiments, the image acquisition device is disposed in the display terminal.

According to still another aspect, a non-volatile computer-readable storage medium is provided. The non-volatile computer-readable storage medium stores one or more computer programs, wherein the one or more computer programs, when executed by a processor, cause the processor to implement a method for recommending information. The method includes:

acquiring video information of a presentation area where a display terminal is located;

performing face image recognition on the video information;

acquiring, in response to determining that a user to which a face image acquired by the recognition belongs is paying attention to the display terminal, preference degrees of the user for a plurality of pieces of to-be-presented information; and

sending target to-be-presented information with a target preference degree to the display terminal.

In some embodiments, before acquiring, the preference degrees of the user for the plurality of pieces of to-be-presented information, the method further includes:

determining, by tracing the face image of the user in the video information, whether a duration for which the user has been facing the display terminal is longer than an attention duration threshold; and

determining, in response to the duration for which the user has been facing the display terminal being longer than the attention duration threshold, that the user is paying attention to the display terminal.

### BRIEF DESCRIPTION OF THE DRAWINGS

The following descriptions of embodiments with reference to the accompanying drawings make the above and/or additional aspects and advantages of the present disclosure apparent and easily understood.

FIG. 1 is a schematic structural diagram of a system for recommending information according to an embodiment of the present disclosure;

FIG. 2 is a schematic structural diagram of a device for recommending information according to an embodiment of the present disclosure;

FIG. 3 is a schematic flowchart of a method for recommending information according to an embodiment of the present disclosure;

FIG. 4 is a schematic flowchart of another method for recommending information according to an embodiment of the present disclosure; and

FIG. 5 is a schematic block diagram of an apparatus for recommending information according to an embodiment of the present disclosure.

### DETAILED DESCRIPTION

The present disclosure is described in detail below. Examples of embodiments of the present disclosure are illustrated in the accompanying drawings. Reference numerals which are the same or similar throughout the accompanying drawings represent the same or similar components or components with the same or similar functions. In addition, if a detailed description of a known technology is unnecessary for the illustrated feature of the present disclosure, it will be omitted. The embodiments described below with reference to the accompanying drawings are examples and used merely to interpret the present disclosure, rather than being construed as limitations to the present disclosure.

It will be understood by those skilled in the art that all terms (including technical and scientific terms) used herein have the same meanings as those commonly understood by those of ordinary skill in the art to which the present disclosure belongs, unless otherwise defined. It should be further understood that terms, such as those defined in the general dictionary, should be interpreted to have the meanings that are consistent with the meanings in the context of the prior art, and will not be interpreted in an idealized or overly formal sense unless specifically defined as herein.

It will be understood by those skilled in the art that the singular forms “a”, “an”, “the”, “said” and “this” may also encompass plural forms, unless otherwise stated. It should be further understood that the term “include/comprise” or variants thereof used in the description of the present disclosure indicates the presence of described features, integers, steps, operations, elements and/or components, but does not preclude the presence or addition of one or more other features, integers, steps, operations, elements, components and/or groups thereof. It should be understood that when an element is “connected” or “coupled” to another element, it may be directly connected or coupled to the another element, or there may be an intermediate element. In addition, “connection” or “coupling” used herein may include wireless connection or wireless coupling. The term “and/or” used herein includes all or any one of one or more of associated listed items or all combinations thereof.

The technical solutions of the present disclosure and the beneficial effects thereof are described in detail below with reference to specific embodiments.

However, existing automated sales schemes require one-to-one direct interaction between a user and a terminal device so that a commodity may be recommended to the user based on the information obtained from the direct interaction.

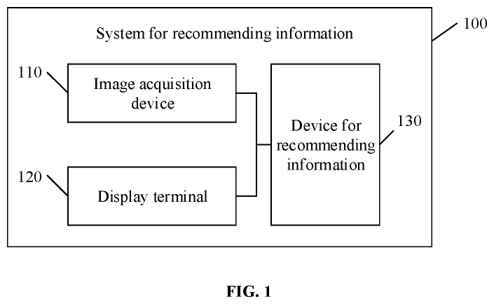

An embodiment of the present disclosure provides a system for recommending information. As shown in FIG. 1, the system for recommending information 100 includes an image acquisition device 110, a display terminal 120 and a device for recommending information 130 according to an embodiment of the present disclosure.

Both the image acquisition device 110 and the display terminal 120 are in communicative connection with the device for recommending information 130.

The image acquisition device 110 is configured to collect an image of the presentation area where the display terminal 120 is located, so as to provide or acquire video information of the presentation area. The display terminal 120 is configured to present, display or exhibit commodity information sent by the device for recommending information 130.

A camera of the image acquisition device 110 faces the presentation area where the display terminal 120 is disposed. The image acquisition device 110 may be integrated into the display terminal 120, or independently disposed outside the display terminal 120 (for example, above the display terminal 120). The image acquisition device 110 may be further configured to communicatively connect to the display terminal 120, and send the collected image or video to the display terminal 120. The display terminal 120 may be further configured to present the image or video.

The device for recommending information 130 according to an embodiment of the present disclosure may include a memory and a processor.

The memory stores one or more computer programs. The processor executes the one or more computer programs to implement any method for recommending information according to any of the subsequent embodiments of the present disclosure.

In some embodiments, the memory in this embodiment of the present disclosure may further store to-be-presented information (for example, the commodity information).

It will be understood by those skilled in the art that, the device for recommending information 130 in the embodiments of the present disclosure may be specially designed and manufactured for a desired purpose, or may include known devices in a general-purpose computer. These devices have a plurality of computer programs stored therein, and these computer programs may be selectively activated or reconstructed. Such computer programs may be stored in device-readable medium or media (for example, computer-readable medium or media) or in any type of medium or media which is/are suitable for storing electronic instructions and separately coupled to a bus.

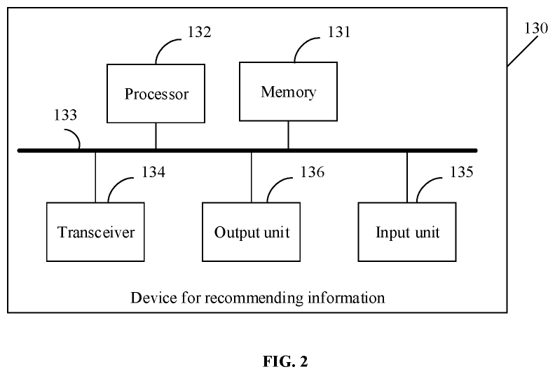

In some embodiments of the present disclosure, a device for recommending information 130 is provided. As shown in FIG. 2, the device for recommending information 130 includes a memory 131 and a processor 132. The memory 131 is electrically connected to the processor 132, for example, via a bus 133.

In some embodiments, the memory 131 is configured to store one or more application codes which are used to implement a solution of the embodiments of the present disclosure. The application code(s) is/are controlled and executed by the processor 132. The processor 132 is configured to execute the application code(s) stored in the memory 131, to implement any of the methods for recommending information in the embodiments of the present disclosure.

The memory 131 may be a read-only memory (ROM) or other types of static storage device capable of storing static information and instructions, may be a random access memory (RAM) or other types of dynamic storage device capable of storing information and instructions, or may be an electrically erasable programmable read-only memory (EEPROM), a compact disc read-only memory (CD-ROM) or other compact disc storage, optical disc storage (including a compact disc, a laser disc, an optical disc, a digital versatile disc, a Blu-ray disc, and the like), a magnetic disk storage medium or other magnetic storage device, or any other medium or media which can carry or store expected program codes in the form of instructions or data structures and can be accessed by the computer, but not limited thereto.

The processor 132 may be a central processing unit (CPU), a general-purpose processor, a digital signal processor (DSP), an application-specific integrated circuit (ASIC), a field programmable gate array (FPGA) or other programmable logical device, a transistor logical device, a hardware component, or any combination thereof. The processor may implement or execute various example logical blocks, modules, and circuits described with reference to content disclosed in the present disclosure. Alternatively, the processor 132 may be a combination of processors implementing computing functions, for example, a combination of one or more microprocessors, or a combination of the DSP and a microprocessor, or the like.

The bus 133 may include a path configured to transfer information among the foregoing components. The bus may be a peripheral component interconnect (PCI) bus or an extended industry standard architecture (EISA) bus. The bus may be classified into an address bus, a data bus, a control bus, and the like. For ease of representation, only one thick line is used to represent the bus in FIG. 2, but this does not mean that there is only one bus or only one type of bus.

In some embodiments, the device for recommending information 130 may further include a transceiver 134. The transceiver 134 may be configured to receive and send signals. The transceiver 134 may allow an electronic device 800 to perform wireless or wired communication with other device to exchange data. It should be noted that, the quantity of the transceiver 134 in practical applications is not limited to one.

In some embodiments, the device for recommending information 130 may further include an input unit 135. The input unit 135 may be configured to receive input numeral, character, image, and/or sound information, or to generate key signal input related to user setting and function control of the device for recommending information 130. The input unit 135 may include but not limited to one or more of a touch screen, a physical keyboard, a functional key (such as a volume control key or a key switch), a trackball, a mouse, a joystick, a shooting apparatus, a pickup, and/or the like.

In some embodiments, the device for recommending information 130 may further include an output unit 136. The output unit 136 may be configured to output or present information processed by the processor 132. The output unit 136 may include but not limited to one or more of a display apparatus, a loudspeaker, a vibration apparatus, and/or the like.

Although FIG. 2 shows a device for recommending information 130 with various apparatuses, it should be understood that there is no need to implement or include all of the shown apparatuses. Alternatively, additional or fewer apparatuses may be implemented or included for the device.

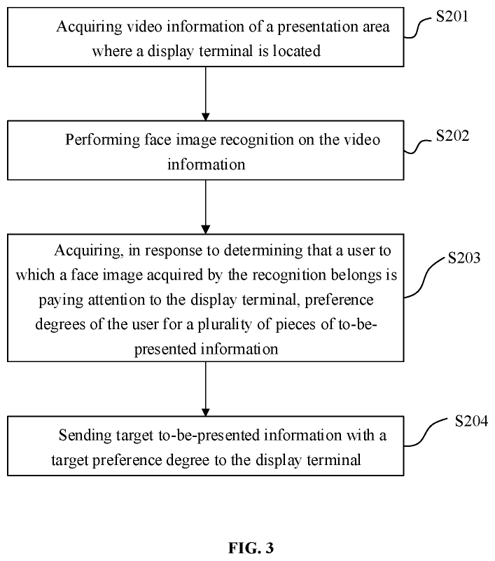

Based on the same concept, an embodiment of the present disclosure provides a method for recommending information. The method may be applied to the device for recommending information 130 according to the embodiments of the present disclosure. As shown in FIG. 3, the method includes the following steps.

In S201, video information of a presentation area where a display terminal is located is acquired.

In S202, face image recognition is performed on the video information.

In S203, in response to determining that a user to which a face image acquired by the recognition belongs is paying attention to the display terminal, preference degrees of the user for a plurality of pieces of to-be-presented information are acquired.

In S204, target to-be-presented information with a target preference degree is sent to the display terminal.

In summary, in the method for recommending information in this embodiment of the present disclosure, whether a user is paying attention or has been paying attention to a display terminal is determined based on video information. After determining that the user is paying attention to the display terminal, corresponding information is sent to the display terminal based on the preference degrees of the user, so as to achieve the information recommendation in the display terminal. In the entire process, the user does not need to interact with the display terminal, which improves the efficiency in information recommendation.

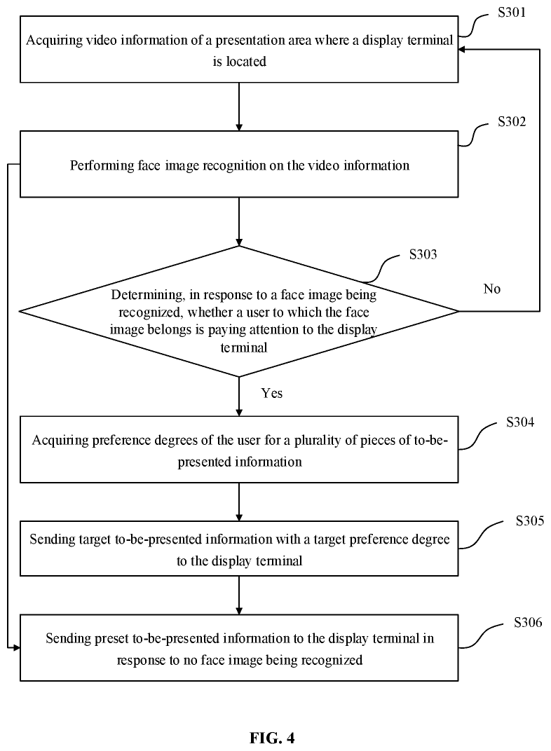

Based on the same concept, an embodiment of the present disclosure provides a method for recommending information. The method may be applied to the device for recommending information 130 according to the embodiments of the present disclosure. As shown in FIG. 4, the method includes the following steps.

In S301, video information of a presentation area where a display terminal is located is acquired.

The video information used in this embodiment of the present disclosure may be collected by an image acquisition device 110 integrated into the display terminal 120 or independently disposed outside the display terminal 120. The video information consists of a plurality of frame pictures.

The video information used in the embodiments of the present disclosure may be historical video information within a time period prior to the current moment. The closer the selected time period is to the current moment, the more accurate the presentation information as provided is.

In S302, face image recognition is performed on the video information. In response to a face image being recognized, S303 is performed; and in response to that no face image has been recognized, S306 is performed.

The device for recommending information may perform face image recognition on each frame or every several frames in the plurality of frames, which is not limited in the embodiments of the present disclosure.

In some embodiments, a face recognition algorithm based on SeetaFace (an open source face recognition engine) may be used when performing the face image recognition. The engine contains three core modules required for building a set of fully automatic face recognition algorithm: a face detection module (SeetaFace Detection), a facial feature point localization module (SeetaFace Alignment), and a face feature extraction and comparison module (SeetaFace Identification). The face detection module uses a cascaded structure integrating traditional man-made features and a multilayer perceptron. The facial feature point localization module regresses the positions of five key feature points (centers of two eyes, nasal tip and two corners of mouth) by cascading a plurality of depth models. The face feature extraction and comparison module extracts face features by using a 9-layer convolutional neural network.

In S303, in response to a face image being recognized, whether a user to which the face image belongs is paying attention to the display terminal is determined. If it is determined that the user is paying attention or has been paying attention to the display terminal, S304 is performed; and if it is determined that the user is not paying attention to the display terminal, S301 is performed.

In some embodiments, whether a duration for which the user faces, or is facing, or has been facing the display terminal 120 is longer than an attention duration threshold is determined by tracing face images of the same user in the video information. It is determined that the user is paying attention to the display terminal 120 when the duration for which the user has been facing the display terminal 120 is longer than the attention duration threshold. The attention duration threshold may be set depending on actual requirements. For example, the attention duration threshold may range from 5 to 10 seconds.

In some embodiments, when the face image recognition is performed on the video information, frame pictures are captured from the video information at a certain frequency. The face image recognition is performed on each captured frame picture, so as to acquire a face feature vector, a face identity document (ID) and positional information of the face image in the frame picture.

In some embodiments, when face images of the same user in the video information are traced, the face ID of the same user in each frame picture is traced according to a time sequence of the respective captured frames, so as to determine whether the user faces the display terminal 120, and further determine the duration for which the user has been facing the display terminal 120.

In S304, preference degrees of the user for a plurality of pieces of to-be-presented information are acquired.

Here, the to-be-presented information may be commodity information.

In some embodiments, a plurality of pieces of to-be-presented information are acquired and user information of the user is also acquired. The user information may include at least one of: a user portrait of the user, or search action feedback information of the user for to-be-presented information. The user portrait may be built from the face image, and the search action feedback information may be feedback information on a presence of the user's search action and is acquired based on or from the video information. Then, the respective preference degree of the user for each piece of to-be-presented information is determined based on the plurality of pieces of to-be-presented information and the user information.

In some embodiments, the manner for acquiring the user portrait in the embodiments of the present disclosure may include:

determining whether the user is a registered user by comparing the face image with registered face images in a face database; building, in response to the user being determined as a registered user, the user portrait of the user based on registration information of the user; and acquiring, in response to the user being determined as an unregistered user, face attribute information of the user by performing face attribute recognition on the face image of the user, and building the user portrait of the user based on the face attribute information of the user.

In one example, the face database stores pre-collected face images of registered users (for example, intra-bank customers of a bank or members of a shopping mall) for a current business premise (for example, a bank, or a shopping mall). When conducting the comparison, the face image recognized in the embodiments of the present disclosure is converted into a 512-dimensional feature vector through a face recognition algorithm, and then, the 512-dimensional feature vector is compared with feature vectors of the face images of the registered users stored in the face database. If the cosine similarity between the feature vector of the recognized face image and a feature vector of a face image of any of the registered users is greater than a preset similarity threshold, the authentication is successful, and it can be determined that the user is a registered user. Otherwise, the user is an unregistered user.

In another example, the face database stores pre-collected face images of registered users and staff for a current business premise. When comparison between the feature vector of the recognized face image and a feature vector of a face image in the face database is successful, whether the user is a staff member or a registered user can be further determined based on a face ID of the face image recognized in the embodiments of the present disclosure. Further, when there are a plurality of users, whether the plurality of users are registered users can be determined by comparing the face images of the plurality of users with the registered face images in the face database, which process may further include:

acquiring a to-be-compared feature vector of the face image of any of the plurality of users; determining that the user is a registered user in response to a cosine similarity between the to-be-compared feature vector and a feature vector of a registered face image in the face database being greater than a similarity threshold; and determining that the user is an unregistered user in response to cosine similarities between the to-be-compared feature vector and the respective feature vectors of each registered face image in the face database being less than or equal to the similarity threshold.

The registration information of the user may include information authorized by the user, such as gender, age, education level, marital status, family relationship, industry, occupation, work unit property, income, assets, loans, housing situation, customer grade, customer activity, and the like.

In some embodiments, acquiring the face attribute information of the user by performing the face attribute recognition on the face image of the user may include: recognizing a face attribute of the face image of the user via a face attribute recognition model; and acquiring the face attribute information output by the face attribute recognition model, wherein the face attribute recognition model includes at least one of: a classification model or a regression model.

The face attributes that can be recognized in the embodiments of the present disclosure may include at least one of: gender, age, face shape, glasses, beard, race, hairstyle, jewelry, makeup, and/or the like.

In some embodiments, a face attribute recognition model according to the embodiments of the present disclosure may perform model training on data sets of different face attributes based on sample data sets of different face attributes by using a ShuffleNet_v2 lightweight network, and input the model obtained from the training into a Softmax classification model, thereby achieving the recognition on different face attributes. As to the recognition on age, in view that a specific value rather than a classification result will be output, the Softmax classification model may be replaced by a regression model for achieving the recognition. As to the multi-object recognition covering the jewelry, makeup and the like, a task may be divided into several sub-tasks, such as earring recognition, necklace recognition, hairpin recognition, eye makeup recognition, lipstick recognition, eyebrow shape recognition, blusher recognition, highlight recognition, and the like. Each sub-task may be separately trained by collecting respective sample data.

When building the user portrait based on the registration information or face attribute information of the user, the registration information or the face attribute information may be directed used as the user portrait. Alternatively, tag information determined or extracted from the registration information or the face attribute information may be used as the user portrait, for example, the age group information that is determined from the age in the face attribute information.

In some embodiments, acquiring the search action feedback information of the user for the to-be-presented information may include:

recognizing, via an action detection model, a search action performed by the user for searching for commodity information from the video information, to acquire gesture information (e.g., the position of a gesture or a posture which represents a search action) in one or more frame pictures represented by the video information involving the search action; and matching the gesture information of each frame picture with a face image nearest to the search action (e.g., the gesture or the posture) in the frame picture, to acquire feedback information of the search action performed by the user for searching for the commodity information. Alternatively, acquiring the search action feedback information of the user for the to-be-presented information may include: determining searched to-be-presented information from the to-be-presented information; performing a search action recognition on the video information to acquire positional information of images corresponding to the search action (e.g., the gesture or the posture) in one or more frame pictures represented by the video information involving the search action; and matching the search action with a face image nearest to the search action in the frame picture and the searched to-be-presented information based on the positional information so as to acquire the search action feedback information. The searched to-be-presented information as searched by the user can represent a preference of the user to some degree.

In some embodiments, determining the searched to-be-presented information from the to-be-presented information may include:

acquiring search information provided by the display terminal; and determining, based on the search information, the searched to-be-presented information from the to-be-presented information. In other words, the searched to-be-presented information searched by the user may be provided by the display terminal.

The search action performed by the user may include a code scanning action, a display terminal touch action, and the like. When the search action as recognized is a code scanning action, in a corresponding frame picture, gesture information acquired from the frame picture may include positional information of a gesture made when the action occurs in the picture and positional information of a mobile terminal (such as a mobile phone, a tablet, or other mobile device) in the picture. When the search action as recognized is a display terminal touch action, in a corresponding frame picture, the gesture information acquired from the frame picture may include positional information of a gesture representing the action in the picture and positional information of the display terminal in the picture.

When matching the gesture information in each frame picture with the nearest face image in the frame picture, the gesture information may be matched with the face ID of the nearest face in the frame picture.

The action detection model according to the embodiments of the present disclosure may be a YOLO model. The model is based on a separate end-to-end network, and includes 24 convolutional layers and 2 full connection layers. The convolutional layers are configured to extract image features, and the full connection layers are configured to predict an image position and detect a target probability value. An output layer divides an image into S×S grids; each grid detects a target falling within the grid; and then the positional information of the grids containing the target as detected and a confidence value are output, where S is a positive integer.

In some embodiments, determining the preference degrees of the user for the plurality of pieces of to-be-presented information based on the plurality of pieces of to-be-presented information and the user information includes: inputting the plurality of pieces of to-be-presented information and the user information into a preference degree computation model and acquiring the preference degrees of the user for the plurality of pieces of to-be-presented information.

Such implementation manner may be applicable to any one of the following cases: face image(s) of at least one user is/are recognized; at least one user is paying attention to the display terminal; or a plurality of users are paying attention to the display terminal. This implementation manner may also be applicable to other cases according to actual requirements.

In some other embodiments, determining the preference degrees of the user for the plurality of pieces of to-be-presented information based on the plurality of pieces of to-be-presented information and the user information may include:

acquiring a respective preference degree of each of the users for each piece of to-be-presented information by inputting the plurality of pieces of to-be-presented information and the user information of the plurality of users into a preference degree computation model; and determining a respective average preference degree for each piece of to-be-presented information based on the respective preference degree of each of the users for each piece of to-be-presented information, wherein the average preference degree for any piece of the plurality of pieces of to-be-presented information indicates an average of the preference degrees of the plurality of users for said piece of to-be-presented information.

Such implementation manner may be applicable to any one of the following cases: face images of more than two users are recognized; or more than two users are paying attention to the display terminal. This implementation manner may also be applicable to other cases according to actual requirements.

The to-be-presented information according to the embodiments of the present disclosure may include multi-dimensional commodity attribute information. Taking bank commodities as an example, the commodity attribute information of a financing product usually includes sale starting date, investment term, purchase starting amount, product type, rate of return, return type, risk level, and the like. The commodity attribute information of a loan product usually includes loan type, quota, interest rate, repayment method, term, and the like.

The preference degree computation model according to the embodiments of the present disclosure is pre-built according to the Factorization Machine. The Factorization Machine is a machine learning method based on a matrix factorization method with a second-order feature association being introduced to improve association between an associated feature and a tag, and is often configured to resolve a feature combination problem under large-scale sparse data. Therefore, the Factorization Machine is often used to predict a conversion rate. By substituting a matrix of the commodity attribute information into the Factorization Machine, an association vector between a user feature and a commodity feature can be acquired; and the respective preference degree of each user for each of the commodities can be computed based on the user features of the user.

Through this implementation manner, preference degrees of different users for one commodity can be comprehensively considered to meet the requirements of different users.

In some embodiments, determining a respective average preference degree of the plurality of users for each commodity based on a respective preference degree of each of the users for each commodity includes:

determining whether each of the plurality of users is a registered user by comparing the face image of each of the plurality of users with registered face images in a face database; determining a respective weight of each of the users, wherein among the plurality of users, registered users have a first weight, and unregistered users have a second weight; and determining a respective average preference degree for each piece of to-be-presented information based on the respective weight of each of the users and the respective preference degree of each of the users for each piece of to-be-presented information, wherein the average preference degree for any piece of the plurality of pieces of to-be-presented information indicates a weighted average of the preference degrees of the plurality of users for said piece of to-be-presented information. Here, the weighted average of the preference degrees for a certain piece of to-be-presented information may indicate an average of weighted preference degrees of the plurality of users for said piece of to-be-presented information. A weighted preference degree of a user for a to-be-presented information refers to a product of a preference degree of the user for the to-be-presented information and the weight of the user.

A magnitude relationship between the first weight and the second weight may be set according to actual requirements. In one example, the first weight may be greater than the second weight, so that more consideration can be given to preference degrees of registered users to satisfy the requirements of the registered users, thereby retaining old users. In another example, the second weight may be greater than the first weight, so that more consideration can be given to preference degrees of unregistered users to satisfy requirements of the unregistered users, thereby developing new users.

In S305, target to-be-presented information with a target preference degree is sent to the display terminal.

The display terminal 120 may display the received target to-be-presented information.

In some embodiments, the plurality of pieces of to-be-presented information are ranked based on the average preference degrees for the plurality of pieces of to-be-presented information; and at least one piece of top-ranked to-be-presented information is sent to the display terminal 120 as the target to-be-presented information.

Such implementation manner may be applicable to any one of the following cases: face image(s) of at least one user is/are recognized; at least one user is paying attention to the display terminal; or a plurality of users are paying attention to the display terminal. This implementation manner may also be applicable to other cases according to actual requirements.

In some embodiments, in a case that only the face image of one user is recognized or only one user is paying attention to the display terminal, when ranking the plurality of pieces of to-be-presented information based on the preference degrees of the user for the plurality of pieces of to-be-presented information, the commodity information of commodities can be ranked in a descending order based on the preference degrees of the user for the plurality of pieces of to-be-presented information.

In some embodiments, in a case that face images of two or more users are recognized or two or more users pay attention to the display terminal, when ranking the plurality of pieces of to-be-presented information based on the preference degrees of the users for the plurality of pieces of to-be-presented information, the commodity information of commodities may be ranked in a descending order based on the preference degrees of each of the users for the plurality of pieces of to-be-presented information. In one example, the number of the users is M, and the number of the commodities is N. In this case, by determining the respective preference degree of each user for each commodity, M×N preference degrees can be acquired. As such, the M×N preference degrees may be ranked in a descending order.

In some other embodiments, commodity information of multiple commodities is ranked based on average preference degrees for the commodities; and at least one piece of top-ranked commodity information is sent to the display terminal 120.

In some embodiments, the commodity information of the commodities is ranked in a descending order based on the average preference degrees for the commodities.

Such implementation manner may be applicable to any one of the following cases: face images of more than two users are recognized; or more than two users are paying attention to the display terminal. This implementation manner may also be applicable to other cases according to actual requirements.

In S306, preset to-be-presented information is sent to the display terminal in response to that no face image is recognized.

The device for recommending information may send to the display terminal the preset to-be-presented information in response to that no face image is recognized, wherein the preset to-be-presented information is at least one of: hot to-be-presented information, the latest to-be-presented information, or random to-be-presented information in the plurality of pieces of to-be-presented information.

When no face image is recognized from any frame picture, it means that no one passes by the presentation area in the duration of the video information. In this case, corresponding commodity information may be sent to the display terminal 120 according to a preset commodity recommendation strategy. The preset commodity recommendation strategy may include any one of: a hot commodity recommendation strategy, a latest commodity recommendation strategy, a random commodity recommendation strategy, and the like.

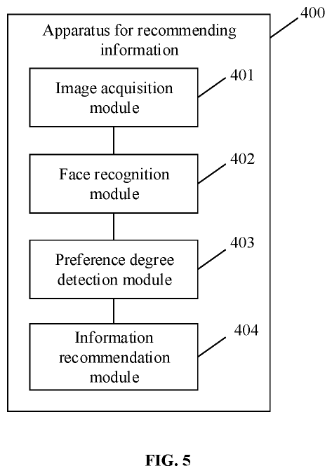

Based on the same concept, an embodiment of the present disclosure provides an apparatus for recommending information. As shown in FIG. 5, the apparatus 400 may include an image acquisition module 401, a face recognition module 402, a preference degree detection module 403, and an information recommendation module 404.

The image acquisition module 401 is configured to acquire video information of a presentation area where a display terminal 120 is located.

The face recognition module 402 is configured to perform face image recognition on the video information.

The preference degree detection module 403 is configured to acquire, in response to determining that a user to which a face image acquired by the recognition belongs is paying attention to the display terminal 120, preference degrees of the user for a plurality of pieces of to-be-presented information.

The information recommendation module 404 is configured to send target to-be-presented information with a target preference degree to the display terminal 120, so that the display terminal 120 presents, displays or exhibits the target to-be-presented information.

In some embodiments, the face recognition module 402 is specifically configured to: determine, by tracing face images of the same user in the video information, whether duration for which the user has been facing the display terminal 120 is longer than an attention duration threshold; and determining, in response to the duration for which the user has been facing the display terminal 120 being longer than the attention duration threshold, that the user is paying attention to the display terminal 120.

In some embodiments, the preference degree detection module 403 is specifically configured to: acquire a plurality of pieces of to-be-presented information; acquire user information of the user, wherein the user information includes at least one of: a user portrait of the user, or search action feedback information of the user for to-be-presented information, the user portrait is built from the face image, and the search action feedback information is feedback information on a presence of the user's search action and is acquired based on the video information; and determine the respective preference degree of the user for each piece of to-be-presented information based on the plurality of pieces of to-be-presented information and the user information.

In some embodiments, the preference degree detection module 403 is specifically configured to: acquire the preference degrees of the user for the plurality of pieces of to-be-presented information by inputting the plurality of pieces of to-be-presented information and the user information into a preference degree computation model, wherein the preference degree computation model is a pre-built model according to the Factorization Machine.

In some other embodiments, the preference degree detection module 403 is specifically configured to: acquire the respective preference degree of each user for each piece of to-be-presented information by inputting the plurality of pieces of to-be-presented information and the user information of the plurality of users into a preference degree computation model, wherein the preference degree computation model is built according to the Factorization Machine; and determine the respective average preference degree for each piece of to-be-presented information based on the respective preference degree of each user for each piece of to-be-presented information, wherein the average preference degree for any piece of the plurality of pieces of to-be-presented information indicates an average of the preference degrees of the plurality of users for said piece of to-be-presented information.

In some embodiments, the preference degree detection module 403 is specifically configured to: determine whether the plurality of users are registered users by comparing the face images of the plurality of users with registered face images in a face database; determine weights of the plurality of users, wherein among the plurality of users, registered users have a first weight, and unregistered users have a second weight; and determine a respective average preference degree for each piece of to-be-presented information based on the respective weight of each of the users and the respective preference degree of each of the users for each piece of to-be-presented information, wherein the average preference degree for any piece of the plurality of pieces of to-be-presented information indicates a weighted average of the preference degrees of the plurality of users for said piece of to-be-presented information.

In some embodiments, the information recommendation module 404 is specifically configured to: rank the plurality of pieces of to-be-presented information based on the preference degrees of the user for the plurality of pieces of to-be-presented information; and send at least one piece of top-ranked to-be-presented information as the target to-be-presented information with the target preference degree to the display terminal.

In some other embodiments, the information recommendation module 404 is specifically configured to: rank the plurality of pieces of to-be-presented information based on the average preference degrees for the plurality of pieces of to-be-presented information; and send at least one piece of top-ranked to-be-presented information as the target to-be-presented information with the target preference degree to the display terminal.

In some embodiments, the apparatus 400 may further include a portrait building module. The portrait building module is configured to build a user portrait in the following fashions:

determining whether a user is a registered user by comparing the face image of the user with registered face images in a face database; building, in response to the user being determined as a registered user, the user portrait of the user based on registration information of the user; and acquiring, in response to the user being determined as an unregistered user, face attribute information of the user by performing a face attribute recognition on the face image of the user, and building the user portrait of the user based on the face attribute information.

In some embodiments, the portrait building module is specifically configured to: recognize the face image of the user via a face attribute recognition model in response to the user being determined as an unregistered user; and acquire the face attribute information output by the face attribute recognition model, wherein the face attribute recognition model includes at least one of: a classification model or a regression model.

In some embodiments, the apparatus 400 may further include an action recognition module. The action recognition module is configured to acquire, in the following fashions, feedback information of the search action performed by the user for searching for certain commodity information:

determining searched to-be-presented information from the to-be-presented information; and

performing a search action recognition on the video information to acquire positional information of an image corresponding to the search action in the video information; and matching the search action with a face image nearest to the search action in a corresponding picture and the searched to-be-presented information based on the positional information so as to acquire the search action feedback information.

The apparatus 400 according to the embodiments of the present disclosure can perform any of the methods for recommending information provided in the embodiments of the present disclosure. Such apparatuses have a similar implementation principle as the methods. For the details that are not described in detail in the apparatus embodiment of the present disclosure, reference can be made to the foregoing respective embodiments. Details are not described here again.

Based on the same concept, an embodiment of the present disclosure provides a non-volatile or non-transitory computer-readable storage medium. The computer-readable storage medium stores one or more computer programs. When a processor executes the one or more computer programs, any method for recommending information in the embodiments of the present disclosure is implemented.

The computer-readable storage medium includes but not limited to any type of disks (including a floppy disk, a hard disk, an optical disk, a CD-ROM, and a magneto-optical disk), a ROM, a RAM, an erasable programmable read-only memory (EPROM), an EEPROM, a flash memory, a magnetic card, or an optical card. In other words, the computer-readable storage medium includes any medium storing or transmitting information in a form which can be read by a device (for example, a computer).

The computer-readable storage medium according to the embodiments of the present disclosure is applicable to any one of the foregoing methods for recommending information. Details are not described here.

When the to-be-presented information is commodity information, the technical solutions according to the embodiments of the present disclosure can implement at least the following beneficial effects.

I: According to the embodiments of the present disclosure, a face image of a user can be acquired by acquiring video information of a presentation area. Whether the user is paying attention to a display terminal can be determined based on the face image. Further, when it is determined that the user is paying attention to the display terminal, a commodity is recommended to the user based on a detected preference degree of the user for a commodity. In the entire process, a terminal device can interact with the user without awareness of the user, which replaces direct interaction between the user and the terminal device, thereby effectively improving processing efficiency, resulting in more intelligent automatic sales services with broadening application scenarios.

II: According to the embodiments of the present disclosure, whether a user is paying attention to a display terminal can be accurately determined by tracing a face image of the user and taking a time factor into consideration; and the subsequent preference degree detection and commodity recommendation are only performed on the users who are paying attention to the display terminal, so that unnecessary commodity recommendation is reduced, and a computation amount is reduced. According to the embodiments of the present disclosure, a user portrait and feedback information of a search action by which a user searches for a commodity can be comprehensively considered for detecting the preference degree of the user for the commodity, so that accuracy of preference degree computation is improved.

III: According to the embodiments of the present disclosure, different user portraits can be built for different types of users by comparing face images and distinguishing between registered users and unregistered users, so that commodity recommendation and presentation are more targeted. According to the embodiments of the present disclosure, face attribute recognition can be performed on the unregistered users, and user portraits of the unregistered users can be built based on face attribute information acquired from the recognition, so that information dimensions of the user portraits are richer. Further, commodity recommendation and presentation are performed on the unregistered users. Compared with the related art in which commodity recommendation is performed on only registered users or only rough recommendation is performed on unregistered users, user portraits built for unregistered users according to the embodiments of the present disclosure are more accurate, so that commodity recommendation and presentation for the unregistered users are more targeted and accurate.

IV: The embodiments of the present disclosure are applicable to a scenario in which there are more than one users. In a case where only one user is paying attention to a display terminal, accurate commodity recommendation can be performed on the user by determining a respective preference degree of the user for each commodity. In a case where a plurality of users pay attention to a display terminal, commodity information can be recommended and presented to each user based on a respective average preference degree of every user for each commodity by comprehensively considering the respective preference degree of each user for each of the commodities, thereby implementing a group recommendation.

V: According to the embodiments of the present disclosure, targeted commodity recommendation and presentation based on actual marketing requirements can be implemented by setting different preference degree weights for registered users and unregistered users. In response to the preference degree weight for the registered users being greater than the preference degree weight for the unregistered users, commodity attention requirements of the registered users can be satisfied first, which helps to retain old users. In response to the preference degree weight for the unregistered users being greater than the preference degree weight for the registered users, commodity attention requirements of the unregistered users can be satisfied first, which helps to develop new users.

It can be understood by those skilled in the art that the steps, measures and solutions in various operations, methods and processes discussed in the present disclosure may be alternated, modified, combined or deleted. Further, other steps, measures and solutions, with the various operations, methods and processes discussed in the present disclosure, may also be alternated, modified, rearranged, split, combined or deleted. Further, the steps, measures and solutions in the related art, with the various operations, methods and processes published in the present disclosure, may also be alternated, modified, rearranged, split, combined or deleted.

In the description of the present disclosure, it should be understood that the terms “first” and “second” are only for the purpose of description and should not be construed as indicating or implying relative importance or implicitly indicating the number of technical features indicated. Thus, the features defined by the terms “first” and “second” may include one or more of the features either explicitly or implicitly. In the description of the present disclosure, unless otherwise specified, “a plurality of” refers to two or more in number.

It should be understood that although the various steps in the flowchart of the drawings are sequentially displayed following the arrows, these steps are not necessarily sequentially performed in the order indicated by the arrows. Unless otherwise explicitly stated herein, the execution of these steps is not strictly limited by the sequence, and may be performed in other sequences. Moreover, at least some of the steps in the flowchart of the drawings may include a plurality of sub-steps or stages, which are not necessarily performed at the same time, but may be executed at different times. The execution order thereof is not necessarily performed sequentially, but may be performed in turn or alternately with at least a portion of other steps or sub-steps or stages of other steps.

According to the present disclosure, the term “and/or” describes an association relation between associated objects and indicates three types of possible relations. For example, A and/or B may include the following three cases: only A exists, both A and B exist, and only B exists. In addition, the character “I” in this specification generally indicates that associated objects are in an “or” relationship.

According to the present disclosure, the term “at least one of A or B” is merely an association relationship that describes associated objects, and represents that there may be three relationships. For example, “at least one of A or B” may represent three cases: only A exists, both A and B exist, and only B exists. Similarly, “at least one of A, B or C” represents that there may be seven relationships: only A exists, only B exists, only C exists, both A and B exist, both A and C exist, both C and B exist, and all of A, B and C exist. Similarly, “at least one of A, B, C or D” represents that there may be fifteen relationships: only A exists, only B exists, only C exists, only D exists, both A and B exist, both A and C exist, both A and D exist, both C and B exist, both D and B exist, both C and D exist, all of A, B and C exist, all of A, B and D exist, all of A, C and D exist, all of B, C and D exist, and all of A, B, C and D exist.

In some embodiments of the present disclosure, a method for recommending information is provided. The method includes:

acquiring video information of a presentation area where a display terminal is located;

recognizing a face image in the video information and determining whether a user to which the face image belongs is paying attention to the display terminal;

detecting preference degrees of the user for commodities in response to determine that the user to which the face image belongs is paying attention to the display terminal; and

sending commodity information conforming to a target preference degree to the display terminal, to enable the display terminal to present the commodity information.

In some embodiments of the present disclosure, an apparatus for recommending information is provided. The apparatus includes:

an image acquisition module configured to acquire video information of a presentation area where a display terminal is located;

a face recognition module configured to recognize a face image in the video information and determine whether a user to which the face image belongs is paying attention to the display terminal;

a preference degree detection module configured to detect preference degrees of the user for commodities in response to determining that the user to which the face image belongs is paying attention to the display terminal; and

a commodity recommendation module configured to send commodity information conforming to a preference degree to the display terminal, to enable the display terminal to present the commodity information.

In some embodiments of the present disclosure, a device for recommending information is provided. The device includes a memory and a processor.

The memory stores one or more computer programs. The processor executes the one or more computer programs to implement the method for recommending information provided in the above embodiments of the present disclosure.

In some embodiments of the present disclosure, a system for recommending information is provided. The system includes:

an image acquisition apparatus, a display terminal, and the device for recommending information provided in the above embodiments of the present disclosure.

Both the image acquisition apparatus and the display terminal are in communicative connection with the device for recommending information.

The image acquisition apparatus is configured to collect an image of a presentation area where the display terminal is located so as to acquire video information of the presentation area.

The display terminal is configured to present the commodity information sent by the device for recommending information.

In some embodiments of the present disclosure, a non-volatile computer-readable storage medium is provided. The computer-readable storage medium stores one or more computer programs. When a processor executes the one or more computer programs, the method for recommending information provided in the above embodiments of the present disclosure is implemented.

The technical solutions according to the embodiments of the present disclosure at least have the following beneficial effects.

According to the embodiments of the present disclosure, a face image of a user can be acquired by acquiring video information of a presentation area. Whether the user is paying attention to a display terminal can be determined based on the face image. Further, when it is determined that the user is paying attention to the display terminal, a commodity is recommended to the user based on a detected preference degree of the user for the commodity. In the entire process, a terminal device can interact with the user without awareness of the user, which replaces direct interaction between the user and the terminal device, thereby effectively improving processing efficiency, resulting in more intelligent automatic sales services with broadening application scenarios.

The above contents only describe some embodiments of the present disclosure, and it should be noted that those skilled in the art may make further improvements and modifications without departing from the principle of the present disclosure, and these improvements and modifications shall be included in the protection scope of the present disclosure.

What is claimed is:

1. A method for recommending information, comprising:
acquiring video information of a presentation area where a display terminal is located;
performing face image recognition on the video information;
acquiring, in response to determining that a user to which a face image acquired by the recognition belongs is paying attention to the display terminal, preference degrees of the user for a plurality of pieces of to-be-presented information; and
sending target to-be-presented information with a target preference degree to the display terminal.

2. The method according to claim 1, wherein before acquiring the preference degrees of the user for the plurality of pieces of to-be-presented information, the method further comprises:
determining, by tracing the face image of the user in the video information, whether a duration for which the user has been facing the display terminal is longer than an attention duration threshold; and
determining, in response to the duration for which the user has been facing the display terminal being longer than the attention duration threshold, that the user is paying attention to the display terminal.

3. The method according to claim 1, wherein acquiring the preference degrees of the user for the plurality of pieces of to-be-presented information comprises:
acquiring the plurality of pieces of to-be-presented information;
acquiring user information of the user, wherein the user information comprises at least one of: a user portrait of the user or search action feedback information of the user for to-be-presented information, wherein the user portrait is built from the face image, and the search action feedback information is feedback information on a presence of the user's search action and is acquired based on the video information; and
determining a respective preference degree of the user for each piece of to-be-presented information based on the plurality of pieces of to-be-presented information and the user information.

4. The method according to claim 3, wherein acquiring the user portrait comprises:
determining whether the user is a registered user by comparing the face image with registered face images in a face database;
building, in response to the user being determined as a registered user, the user portrait of the user based on registration information of the user; and
acquiring, in response to the user being determined as an unregistered user, face attribute information of the user by performing face attribute recognition on the face image of the user, and building the user portrait of the user based on the face attribute information.

5. The method according to claim 4, wherein acquiring the face attribute information of the user by performing the face attribute recognition on the face image of the user comprises:
recognizing the face image of the user via a face attribute recognition model; and
acquiring the face attribute information output by the face attribute recognition model,
wherein the face attribute recognition model comprises at least one of: a classification model or a regression model.

6. The method according to claim 3, wherein acquiring the search action feedback information of the user for the to-be-presented information comprises:
determining searched to-be-presented information from the to-be-presented information;
acquiring positional information of an image corresponding to the search action in the video information by performing search action recognition on the video information; and
acquiring the search action feedback information by matching the search action with a nearest face image and the searched to-be-presented information based on the positional information.

7. The method according to claim 6, wherein determining the searched to-be-presented information from the to-be-presented information comprises:
acquiring search information provided by the display terminal; and
determining, based on the search information, the searched to-be-presented information from the to-be-presented information.

8. The method according to claim 7, wherein the search action comprises any one of: a code scanning action or a touch operation on the display terminal.

9. The method according to claim 3, wherein determining the respective preference degree of the user for each piece of to-be-presented information comprises:
acquiring the respective preference degrees of the user for the plurality of pieces of to-be-presented information by inputting the plurality of pieces of to-be-presented information and the user information into a preference degree computation model, wherein the preference degree computation model is pre-built according to a Factorization Machine.

10. The method according to claim 9, wherein sending the target to-be-presented information with the target preference degree to the display terminal comprises:
ranking the plurality of pieces of to-be-presented information based on the preference degrees of the user for the plurality of pieces of to-be-presented information; and
sending at least one piece of top-ranked to-be-presented information as the target to-be-presented information to the display terminal.

11. The method according to claim 3, wherein there are a plurality of users, and determining the respective preference degree of the user for each piece of to-be-presented information based on the plurality of pieces of to-be-presented information and the user information comprises:
acquiring the respective preference degree of each of the users for each piece of to-be-presented information by inputting the plurality of pieces of to-be-presented information and the user information of the plurality of users into a preference degree computation model, wherein the preference degree computation model is built according to a Factorization Machine; and
determining a respective average preference degree for each piece of to-be-presented information based on the respective preference degree of each of the users for each piece of to-be-presented information, wherein the average preference degree for any piece of to-be-presented information indicates an average of the preference degrees of the plurality of users for the piece of to-be-presented information.

12. The method according to claim 11, wherein sending the target to-be-presented information with the target preference degree to the display terminal comprises:
ranking the plurality of pieces of to-be-presented information based on the average preference degrees for the plurality of pieces of to-be-presented information; and
sending at least one piece of top-ranked to-be-presented information as the target to-be-presented information to the display terminal.

13. The method according to claim 11, wherein determining the respective average preference degree for each piece of to-be-presented information based on the respective preference degree of each of the users for each piece of to-be-presented information comprises:
determining whether the plurality of users are registered users by comparing face images of the plurality of users with registered face images in a face database;
determining weights of the plurality of users, wherein among the plurality of users, registered users have a first weight, and unregistered users have a second weight; and
determining a respective average preference degree for each piece of to-be-presented information based on the respective weight of each of the users and the respective preference degree of each of the users for each piece of to-be-presented information, wherein the average preference degree for any piece of to-be-presented information indicates a weighted average of the preference degrees of the plurality of users for the piece of to-be-presented information.

14. The method according to claim 13, wherein determining whether the plurality of users are registered users by comparing the face images of the plurality of users with the registered face images in the face database comprises:
acquiring a to-be-compared feature vector of the face image of any one of the users;
determining that the user is a registered user in response to a cosine similarity between the to-be-compared feature vector and a feature vector of a registered face image in the face database being greater than a similarity threshold; and
determining that the user is an unregistered user in response to cosine similarities between the to-be-compared feature vector and respective feature vectors of each registered face image in the face database being less than or equal to the similarity threshold.

15. The method according to claim 1, wherein after performing the face image recognition on the video information, the method further comprises:
sending preset to-be-presented information to the display terminal in response to no face image being recognized, wherein the preset to-be-presented information is at least one of: hot to-be-presented information, latest to-be-presented information, or random to-be-presented information in the plurality of pieces of to-be-presented information.

16. A device for recommending information, comprising: a memory and a processor, wherein
the memory stores one or more computer programs, and the processor executes the one or more computer programs to perform:
acquiring video information of a presentation area where a display terminal is located;
performing face image recognition on the video information;
acquiring, in response to determining that a user to which a face image acquired by the recognition belongs is paying attention to the display terminal, preference degrees of the user for a plurality of pieces of to-be-presented information; and
sending target to-be-presented information with a target preference degree to the display terminal.

17. A system for recommending information, comprising: an image acquisition device, a display terminal, and the device for recommending information as defined in claim 16, wherein
both the image acquisition device and the display terminal are in communicative connection with the device for recommending information;
the image acquisition device is configured to collect an image of the presentation area where the display terminal is located so as to provide the video information of the presentation area; and
the display terminal is configured to present the target to-be-presented information sent by the device for recommending information.

18. The system according to claim 17, wherein the image acquisition device is disposed in the display terminal.

19. A non-volatile computer-readable storage medium storing one or more computer programs, wherein the one or more computer programs, when executed by a processor, cause the processor to implement a method for recommending information comprising:
acquiring video information of a presentation area where a display terminal is located;
performing face image recognition on the video information;
acquiring, in response to determining that a user to which a face image acquired by the recognition belongs is paying attention to the display terminal, preference degrees of the user for a plurality of pieces of to-be-presented information; and
sending target to-be-presented information with a target preference degree to the display terminal.

20. The non-volatile computer-readable storage medium according to claim 19, wherein before acquiring the preference degrees of the user for the plurality of pieces of to-be-presented information, the method further comprises:
determining, by tracing the face image of the user in the video information, whether a duration for which the user has been facing the display terminal is longer than an attention duration threshold; and
determining, in response to the duration for which the user has been facing the display terminal being longer than the attention duration threshold, that the user is paying attention to the display terminal.
